(19) United States
(12) Patent Application Publication
(10) Pub. No.: US 2014/0092496 A1
(43) Pub. Date: Apr. 3, 2014

(54) Color Filter and Related Manufacturing Method Thereof

(71) Applicant: SHENZHEN CHINA STAR OPTOELECTRONICS TECHNOLOGY CO., LTD., Shenzhen, Guangdong (CN)

(72) Inventor: Jiwang Yuan, Shenzhen (CN)

(73) Assignee: SHENZHEN CHINA STAR OPTOELECTRONICS TECHNOLOGY CO., LTD, Shenzhen, Guangdong (CN)

(21) Appl. No.: 13/696,031

(22) PCT Filed: Oct. 8, 2012
(86) PCT No.: PCT/CN12/82574

§ 371 Date: Nov. 2, 2012

(30) Foreign Application Priority Data
Sep. 29, 2012 (CN) 201210370695.3

(51) Int. Cl. G02B 5/20

(52) U.S. Cl. CPC G02B 5/201
USPC 359/891; 216/24

(57) ABSTRACT

The present invention discloses a manufacturing method for manufacturing a color filter including: providing a glass substrate; forming an opaque layer on the glass substrate; utilizing a mask having a plurality of regions having different levels of light transmittance to expose the opaque layer; etching the opaque layer to generate a black matrix according to the exposing result, wherein the black matrix has a first region and a second region, and a height of the first region is lower than a height of the second region; and generating a color film layer on the glass substrate and the black matrix. The color film layer and the black matrix layer overlaps in the first region of the black matrix layer.

### BACKGROUND OF THE INVENTION

1. Field of the Invention

The invention relates to an LCD, and more particularly, to a color filter and related manufacturing method thereof.

2. Description of the Prior Art

Liquid crystal display (LCD) has been widely used in modern information processing equipments such as computers, mobile phones, personal digital assistances (PDA) because of its advantages of light, thin, low power consumption. Generally speaking, the LCD comprises an LCD panel and backlight module. Because the LCD is not self-lighting, the LCD needs the light source inside the backlight module to generate lights. The lights pass through the liquid crystals of the LCD to adjust the luminance according to the rotation of the liquid crystals such that an image can be output to users.

The color filter is a necessary component of the LCD. In general, the color filter is placed in front of the light source. The lights are separated by the color filter into red lights, blue lights, and green lights. In this way, the image can be shown by LCD.

Please refer to FIG. 1, which is a diagram showing the structure of a conventional color filter 100. The color filter 100 comprises a glass substrate 110, a black matrix layer 120, a red film layer 131, a green film layer 132, and a blue film layer 133. The red film layer 131, the green film layer 132, and a blue film layer 133 are called as a color film layer. The LCD separates the white lights into red lights, blue lights, and green lights by these color film layers such that a colorful image can be displayed.

From FIG. 1, it can be seen that the red film layer 131, the green film layer 132, and a blue film layer 133 overlaps the black matrix layer 120 in overlapping regions. The overlapping regions are used to prevent the lights from emitting from the edge of each color layer. However, these overlapping regions are not well handled by the etching process. This makes the height of the overlapping regions of the color film layer and the black matrix layer 120 is higher than the non-overlapping regions. In other words, the overlapping regions seem like bulges, which form a height difference “d” between the overlapping regions and the non-overlapping regions. The height difference d may ruin the arrangement of liquid crystals on the edges of the sub-pixel. Therefore, a solution is needed to solve the above-mentioned problem.

### SUMMARY OF THE INVENTION

It is therefore one of the primary objectives of the claimed invention to provide an color filter substrate and related manufacturing method, which utilizes a mask having a plurality of regions having different levels of light transmittance to manufacture the black matrix layer. In this way, in the following etching process, different regions of the black matrix layer are etched in different degrees in order to make the height of the overlapping region of the color layer and the black matrix layer substantially equal to the height of the non-overlapping region. In this way, the problem caused by the conventional height difference can be removed, and the arrangement of liquid crystals on the edges of sub-pixels can thus be better.

According to the present invention, a manufacturing method for manufacturing a color filter substrate comprises: providing a glass substrate; forming an opaque layer on the glass substrate; utilizing a mask having a plurality of regions having different levels of light transmittance to expose the opaque layer; etching the opaque layer to generate a black matrix according to the exposing result, wherein the black matrix has a first region and a second region, and a height of the first region is lower than a height of the second region; and generating a color film layer on the glass substrate and the black matrix, wherein the color film layer and the black matrix layer overlaps in the first region of the black matrix layer.

In one aspect of the present invention, the mask is a half-tone mask.

In another aspect of the present invention, the step of generating the color film layer comprises: generating a red film layer on the glass substrate and the black matrix layer; generating a green film layer on the glass substrate and the black matrix layer; and generating a blue film layer on the glass substrate and the black matrix layer.

In another aspect of the present invention, the color film layer comprises a red color filter, a green color filter, and blue color filter.

According to the present invention, a color filter substrate comprises: a glass substrate; a black matrix layer, placed on the glass substrate, the black matrix layer the black matrix has a first region and a second region, wherein a height of the first region is lower than a height of the second region; and a color film layer, placed on the glass substrate and the black matrix layer. The color film layer and the black matrix layer overlaps in the first region of the black matrix layer.

In one aspect of the present invention, the black matrix layer is manufacturing by utilizing a mask having a plurality of regions having different levels of light transmittance to expose an opaque layer and etching the opaque layer according to the exposing result.

In another aspect of the present invention, the mask is a half-tone mask.

In another aspect of the present invention, the color film layer comprises a red color filter, a green color filter, and blue color filter.

The present invention provides a color filter substrate and related manufacturing method, which utilizes a mask having a plurality of regions having different levels of light transmittance to manufacture the black matrix layer. Therefore, the black matrix layer is exposed in different degrees. In this way, in the following etching process, different regions having different exposing results are etched in different degrees. This allows the height of the overlapping region of the color film layer and the black matrix layer substantially equal to the height of the non-overlapping region of the color film layer and the black matrix layer. Therefore, the present invention can remove the problem caused by the height difference, and improve the arrangement of the liquid crystals on the edges of sub-pixels.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a conventional color filter substrate.

FIG. 2 is a diagram showing a color filter substrate according to a preferred embodiment of the present invention.

FIG. 3 to FIG. 5 show a manufacturing process of the color filter substrate shown in FIG. 2.

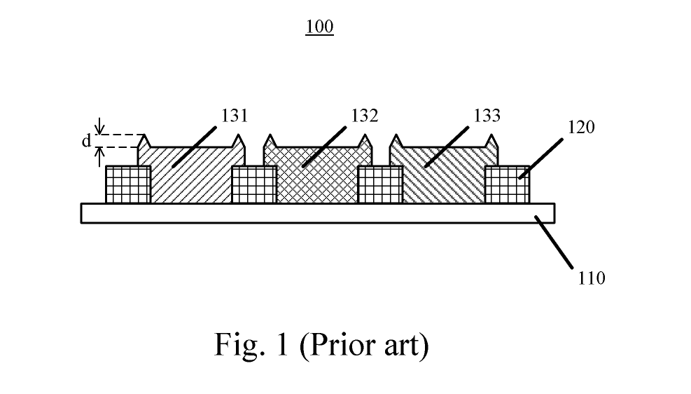

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

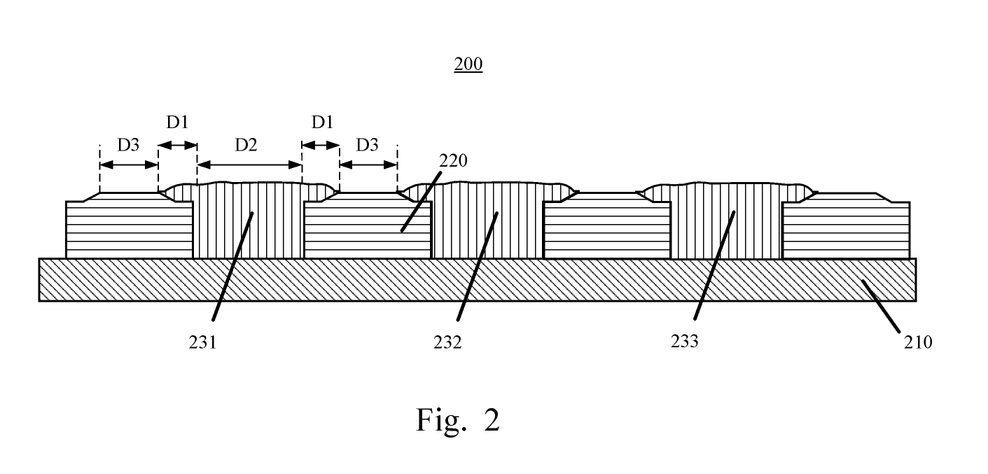

Please refer to FIG. 2, which is a diagram showing a color filter substrate 200 according to a second embodiment of the present invention. The color filter substrate 200 comprises a glass substrate 210, a black matrix layer 220, a red film layer 231, a green film layer 232, and a blue film layer 233. The red film layer 231, the green film layer 232, and a blue film layer 233 are called as a color film layer. The LCD separates the white light into red light, blue light, and green light by these color film layers such that a colorful image can be displayed.

From FIG. 2, it can be seen that the height of the black matrix layer 220 varies. The height of the overlapping region D1 is lower than that of the non-overlapping region D2 of the black matrix layer 220 and color film layer. In this way, through appropriate design, the height difference between the first region D1 and the second region D2 can be removed. Taking the red film layer 231 as an example, the surface of the red film layer 231 is flat and no height difference exists. This is achieved due that the black matrix layer 220 has a lower height in the first region D1 to compensate for the height difference between the first region D1 and the second region D2 of the red film layer 231 occurred in the prior art.

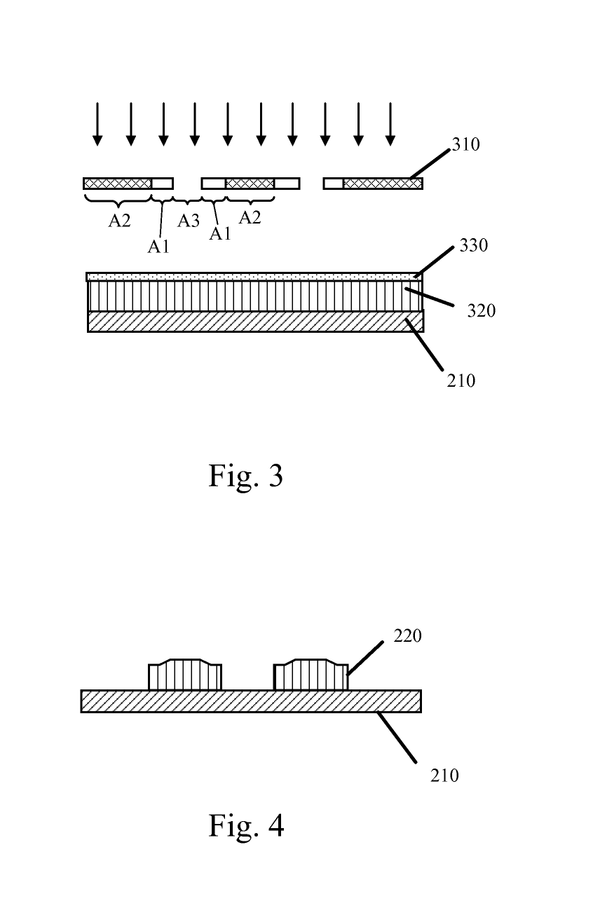

Please refer to FIG. 3 to FIG. 5, which show a manufacturing process of the color filter substrate 200 shown in FIG. 2. Firstly, an opaque layer 320 (it will become the black matrix layer later) is formed on the glass substrate 210, and a photoresist 330 is spread on the opaque layer 320.

And then, a half-tone mask 310 is utilized to expose the opaque layer 320. The half-tone mask 310 has a plurality of regions having different levels of light transmittance. For example, the half-tone mask 310 has three regions A1, A2, and A3. The region A1 represents a region that lights can partial pass through. The region A2 represents a region that lights cannot pass through. The region A3 represents a region that lights can completely pass through. Therefore, the present invention can properly utilize the half-tone mask 310 to expose the opaque layer 320.

For example, the region A1 of the half-tone mask 310 can align with the region, which is going to be partially removed, of the opaque layer 320 (such as the region D1 shown in FIG. 2). The region A2 of the half-tone mask 310 can align with the region, which is going to be completely removed, of the opaque layer 320 (such as the region D2 shown in FIG. 2). The region A3 of the half-tone mask 310 can align with the region, which is going to be retained, of the opaque layer 320 (such as the region D3 shown in FIG. 2). Because the regions A1, A2, and A3 of half-tone mask 310 have different levels of light transmittance, the photoresist 330 is exposed with different exposures according to the levels of light transmittance of the half-tone mask 310.

Please refer to FIG. 4. A chemical solution is used to remove partial opaque layer 320 corresponding to the first region D1 and to remove all opaque layer 320 corresponding to the second region D2. The opaque layer 320 corresponding to the third region D3 is retained due to the protection of the photoresist. At last, another chemical solution is used to remove the photoresist.

In this way, after the etching process, the opaque layer 320 becomes the black matrix layer 220 shown in FIG. 2. Because the exposure process has been performed in different degrees, the following etching process is performed according to the exposing result. That is, the opaque layer 320 corresponding to the first region D1 is partially etched, the opaque layer 320 corresponding to the region D3 are completely retained, and the opaque layer 320 corresponding to the third region D2 is completely etched.

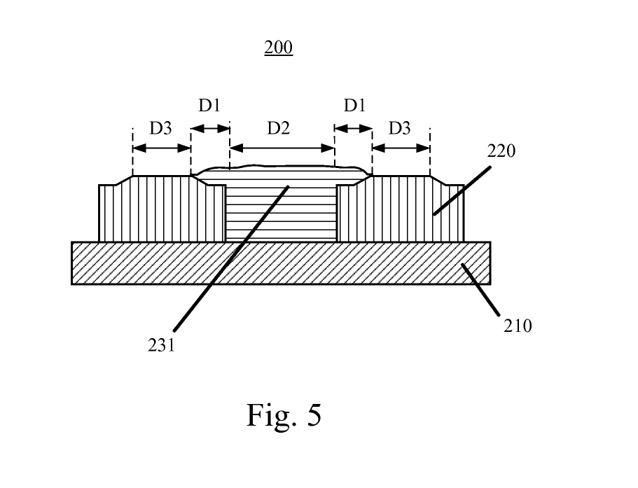

Please refer to FIG. 5. The color film layer is formed on the glass substrate 210 and the black matrix layer 220. Please note, for simplicity, only the red film layer 231 is shown in FIG. 2. From FIG. 5, it can be clearly see that the black matrix layer 220 has optimized height difference. Therefore, when the red film layer 231 is formed, the surface of the red film layer 231 is flat without having any height difference.

Please note, although only the manufacturing process of the red film layer 231 is depicted in FIG. 5. This is only for simplicity. In the actual implementation, the green film layer 232 and the blue film layer 233 are also formed. One having ordinary skills can understand the manufacturing process of the green film layer 232 and the blue film layer 233, and further illustrations are thus omitted here.

Please note that the manufacturing processes of color film layer are not limited. The color film can be manufactured through printing, depositing, or any other manufacturing processes. Theses also obey the spirit of the present invention.

In contrast to the related art, the present invention provides a color filter substrate and related manufacturing method, which utilizes a mask having a plurality of regions having different levels of light transmittance to manufacture the black matrix layer. Therefore, the opaque layer is exposed in different degrees. In this way, in the following etching process, different regions of the opaque layer having different exposing results are etched in different degrees so as to form the black matrix layer. This allows the height of the overlapping region of the color film layer and the black matrix layer substantially equal to the height of the non-overlapping region of the color film layer and the black matrix layer. Therefore, the present invention can remove the problem caused by the height difference, and improve the arrangement of the liquid crystals on the edges of sub-pixels.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A manufacturing method for manufacturing a color filter, comprising:
providing a glass substrate;
forming an opaque layer on the glass substrate;
utilizing a mask having a plurality of regions having different levels of light transmittance to expose the opaque layer;
etching the opaque layer to generate a black matrix according to the exposing result, wherein the black matrix has a first region and a second region, and a height of the first region is lower than a height of the second region; and
generating a color film layer on the glass substrate and the black matrix, wherein the color film layer and the black matrix layer overlaps in the first region of the black matrix layer.

2. The manufacturing method of claim 1, wherein the mask is a half-tone mask.

3. The manufacturing method of claim 2, wherein the step of generating the color film layer comprises:
generating a red film layer on the glass substrate and the black matrix layer;
generating a green film layer on the glass substrate and the black matrix layer; and
generating a blue film layer on the glass substrate and the black matrix layer.

4. The manufacturing method of claim 1, wherein the color film layer comprises a red color filter, a green color filter, and blue color filter.

5. A color filter substrate comprising:
a glass substrate;
a black matrix layer, placed on the glass substrate, the black matrix layer the black matrix has a first region and a second region, wherein a height of the first region is lower than a height of the second region; and
a color film layer, placed on the glass substrate and the black matrix layer;
wherein the color film layer and the black matrix layer overlaps in the first region of the black matrix layer.

6. The color filter substrate of claim 5, wherein the black matrix layer is manufacturing by utilizing a mask having a plurality of regions having different levels of light transmittance to expose an opaque layer and etching the opaque layer according to the exposing result.

7. The color filter substrate of claim 6, wherein the mask is a half-tone mask.

8. The color filter substrate of claim 5, wherein the color film layer comprises a red color filter, a green color filter, and blue color filter.
